(19) United States
(12) Patent Application Publication
(10) Pub. No.: US 2007/0177141 A1
(43) Pub. Date: Aug. 2, 2007

(54) Optical spectrum analyzer

(75) Inventors: Kazushi Ohishi, Tokyo (JP); Hiroshi Ohta, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 11/699,463

(22) Filed: Jan. 30, 2007

(30) Foreign Application Priority Data
Jan. 31, 2006 (JP) 2006-023140

(51) Int. Cl. G01J 3/06; G01J 3/28

(52) U.S. Cl. 356/308; 356/328

(57) ABSTRACT

An optical spectrum analyzer includes an optical section 130 for executing light dispersion into a spectrum and wavelength sweep for input measured light, converting the measured light into an electric signal, and outputting the electric signal, a control section 101 for controlling the wavelength sweep of the optical section and outputting a sampling clock of a period shifting from a cycle period of the measured light for each wavelength of the wavelength sweep, and a measurement section 140 for executing sequential sampling of the electric signal from the optical section for each sampling clock.

### TECHNICAL FIELD

The present disclosure relates to an optical spectrum analyzer for measuring the spectrum of measured light with a plurality of pulses occurring repeatedly in one frame period. More specifically, the present disclosure relates to an optical spectrum analyzer for enabling the user to observe instantaneous change in an optical spectrum.

### RELATED ART

FIG. 8 is a drawing to show the configuration of a measurement system of an optical spectrum analyzer according to a representative Czerny-Turner monochromator system.

In FIG. 8, an optical fiber 10 has an incidence end on which measured light is incident, and transmits the incident measured light. An emission end of the optical fiber 10 on the side of an optical section 130 described later is connected to an incidence slit 131 in the optical section 130 described later.

A motor controller 110 outputs a ramp wave signal of a predetermined waveform for driving a motor 134 for rotating a diffraction grating 135 described later, and has output connected to a divider 120.

The ramp wave signal of the predetermined waveform supplied from the motor controller 110 is input to the divider 120, which then divides the ramp wave signal for output. The divided output is supplied to the motor 134 and a signal processing section 160 described later.

The optical section 130 executes light dispersion into a spectrum and wavelength sweep for the measured light emitted from the output end of the optical fiber 10, converts the measured light into an electric signal, and outputs the electric signal. It has the incidence slit 131, a concave mirror 132, the motor 134, the diffraction grating 135, a concave mirror 136, an exit slit 137, and a photodetector 138.

The incidence slit 131 is placed in the proximity of the emission end of the optical fiber 10 for limiting a light flux so that the measured light having a predetermined emission angle, of the measured light emitted from the emission end of the optical fiber 10 arrives at the concave mirror 132.

The concave mirror 132 is a kind of collimator means for converting the measured light having a spread angle from the optical fiber 10 incident through the incidence slit 131 into collimated light, and reflects the measured light converted into the collimated light toward the diffraction grating 135.

The motor 134 is a rotation drive source to which the ramp wave signal provided by the divider 120 is supplied as a drive signal, and drives the diffraction grating 135 by rotation responsive to the ramp wave signal.

The diffraction grating 135 is an optical element for executing light dispersion of the diffraction angle responsive to the wavelength by reflection interference of a plurality of minute parallel grooves. It receives collimated measured light from the concave mirror 132 and diffracts the dispersed measured light in the direction of the concave mirror 136.

The concave mirror 136 is a kind of light condensing means for condensing dispersed diffraction light which is collimated light for each wavelength from the diffraction grating 135. It condenses the diffraction light toward the photodetector 138.

The exit slit 137 is placed in the proximity of the light detection face of the photodetector 138 for limiting a light flux so that the measured light of a predetermined wavelength, of the measured light dispersed through the diffraction grating 135 and condensed on the concave mirror 136 toward the photodetector 138.

The photodetector 138 is a photoelectric conversion element for detecting the measured light of the predetermined wavelength emitted through the exit slit 137 and outputting an electric signal, and has output connected to an A-D converter 150.

The A-D converter 150 has input to which the output of the photodetector 138 is connected, executes A-D conversion in response to a sampling clock, outputs a digital signal, and has output connected to the signal processing section 160.

A sampling clock generation section 152 generates a sampling clock of a predetermined frequency and outputs the sampling clock to the A-D converter 150.

The signal processing section 160 performs signal processing of the digital signal from the A-D converter 150, the sampling result of the measured light of the predetermined wavelength, with the ramp wave signal provided by the divider 120 as a trigger, generates waveform information of the spectrum component of the measured light, and outputs the waveform information to a waveform display 170.

The waveform information output from the signal processing section 160 is input to the waveform display 170 for producing various displays of the waveform information in the forms of graphs and numeric values on a display screen.

In FIG. 8, measured light is incident on the optical section 130 from the emission end of the optical fiber 10. At this time, the incidence slit 131 limits a light flux so that the measured light having a predetermined emission angle, of the measured light emitted from the emission end of the optical fiber 10 arrives at the concave mirror 132.

The measured light emitted from the emission end of the optical fiber 10 and arriving at the concave mirror 132 arrives at the diffraction grating 135 as collimated light.

At this time, the measured light diffracted through the diffraction grating 135 is dispersed into a spectrum and is in a state in which the diffraction angle changes for each wavelength.

Therefore, the wavelength of the measured light diffracted through the diffraction grating 135 and then condensed on the concave mirror 136 and emitted through the exit slit 137 changes in synchronization with rotation of the diffraction grating 135 and wavelength sweep is realized.

The measured light emitted through the exit slit 137 is detected at the photodetector 138, which then executes photoelectric conversion of the measured light into an electric signal. The electric signal detected and generated by the photodetector 138 is converted into a digital signal by the A-D converter 150 driven according to a sampling clock from the sampling clock generation section 152.

The signal processing section 160 performs signal processing of the digital signal with a ramp wave signal as a trigger and generates waveform information of the spectrum component of the measured light, and the waveform information is displayed on the waveform display 170. That is, the emission timing through the exit slit 137 changes depending on the wavelength of the light dispersed through the diffraction grating 135 driven by the motor 134 and thus the time response becomes an optical spectrum. Here, the time (light detection timing) can be converted into the wavelength according to the angle of the diffraction grating 135.

FIG. 9 is a time chart at the measurement time with the optical spectrum analyzer shown in FIG. 8. FIG. 9(a) shows the pulse-like waveform of measured light and FIG. 9(b) shows the waveform of a ramp wave signal from the motor controller 110 for performing wavelength sweep of measured light.

FIG. 9(c) shows an electric signal output from the photodetector 138 in the wavelength sweep state, FIG. 9(d) shows the waveform of a sampling clock supplied by the sampling clock generation section 152 to the A-D converter 150, and FIG. 9(e) shows the sampling waveform when output of the photodetector 138 is sampled in the A-D converter 150 in response to the sampling clock.

FIG. 10 is a waveform drawing to schematically show the relationship between the wavelength and the time. FIG. 10(a) is a three-dimensional waveform drawing to schematically show the relationship between the wavelength and the time, FIG. 10(b) is a two-dimensional waveform drawing to show the characteristic of the wavelength with no time information, and FIG. 10(c) is a schematic representation to schematically show the state of the wavelength in the time axis direction.

Here, to mechanically rotate the diffraction grating 135 by the motor 134, a number of light pulses of measured light are input as shown in FIG. 9(a) during one sweep (one crest of ramp wave in FIG. 9(b)).

Therefore, an optical spectrum averaged in terms of time in a state in which time information (see FIG. 10(c)) is lost is observed like the two-dimensional graph of the light strength relative to the wavelength (FIG. 10(b)). The sampling period is determined by the clock of the A-D converter 150.

Relevant arts to the optical spectrum analyzer for thus executing measurement are described in the following patent document 1, etc.:

[Patent document 1] Japanese Patent No. 3106979

[Patent document 2] Japanese Patent No. 3254932

Such an optical spectrum analyzer is used as a wavelength monitor of an optical network, for example. In a next-generation optical network, data is relayed with a light signal intact without converting the light signal into an electric signal. Such an optical network uses a technology called burst switching for switching a path at high speed according to the wavelength for transferring data. The time required for path switching of the burst switching is about 1 ms and an optical spectrum analyzer that can cope with high-speed wavelength switching becomes necessary.

However, in the mechanical wavelength sweep technique of rotating the diffraction grating 135 using the motor as shown in FIG. 8, a time of about one second is required with sweep span 1000 nm.

The three-dimensional graph shown in FIG. 10(a) is an example wherein the wavelength of the measured light is switched instantaneously; in the mechanical sweeping technique in the related art using a motor, the user can observe only an optical spectrum averaged in a state in which information in the time axis direction is lost like the two-dimensional graph in FIG. 10(b).

When the optical spectrum changes instantaneously as in FIG. 10(a), the optical spectrum changes while the diffraction grating rotates, if the timing is missed, there is also a possibility that erroneous information such that an optical spectrum is not seen at all may be provided. If a high-speed scanner is used, instantaneous optical spectral change of nano-order or less in a pulse cannot be captured.

### SUMMARY

Embodiments of the present invention provide an optical spectrum analyzer for enabling the user to observe an instantaneous optical spectrum even if a mechanical sweep technique is used when the spectrum of measured light occurring repeatedly is measured.

One or more embodiments of the invention is as follows:

(1) The first aspect of the invention provides an optical spectrum analyzer including an optical section for executing light dispersion into a spectrum and wavelength sweep for input measured light, converting the measured light into an electric signal, and outputting the electric signal; a control section for controlling the wavelength sweep of the optical section and outputting a sampling clock of a period shifting from a cycle period of the measured light for each wavelength of the wavelength sweep; and a measurement section for executing sequential sampling of the electric signal from the optical section for each sampling clock.

(2) The second aspect of the invention provides an optical spectrum analyzer including an optical section for executing light dispersion into a spectrum and wavelength sweep for input measured light, converting the measured light into an electric signal, and outputting the electric signal;

a measurement section for processing the electric signal from the optical section for each sampling clock; and

a control section for controlling the wavelength sweep of the optical section and changing the timing of sampling of the measurement section for each period of the wavelength sweep.

(3) The third aspect of the invention, in the optical spectrum analyzer according to the first or second aspect of the invention, the measurement section has a sampling head to which the electric signal from the optical section is input, the sampling head for sampling according to the sampling clock; and an A-D converter to which output of the sampling head is input, the A-D converter for converting analog data into digital data according to the sampling clock.

(4) In the fourth aspect of the invention, the optical spectrum analyzer according to any of the first to third aspects of the invention further includes a waveform display for producing three-dimensional waveform display based on the measurement result of the measurement section.

(5) In the fifth aspect of the invention, in the optical spectrum analyzer as claimed in any of the first to fourth aspects of the invention, the optical section has a diffraction grating for executing light dispersion of the measured light into a spectrum; and a motor for rotating the diffraction grating according to a command of the control section.

(6) In the sixth aspect of the invention, in the optical spectrum analyzer according to any of first to fourth aspects of the invention, the optical section has a deflection section to which the measured light is input, the deflection section for deflecting the measured light according to a command of the control section; and a diffraction grating on which diffraction light provided by the deflection section is made incident, the diffraction grating for executing light dispersion into a spectrum.

(7) In seventh aspect of the invention, in the optical spectrum analyzer according to any of the first to sixth aspects of the invention, the measured light is synchronized with the sampling clock.

(8) In the eighth aspect of the invention, in the optical spectrum analyzer according to any of the first to sixth aspect of the invention, the measured light is repeated every frame period with the sampling clock and frame period synchronized with each other.

According to one or more embodiments of the invention described above, the following advantages can be provided:

In one or more embodiments of the invention described above, when the optical section executes light dispersion into a spectrum and wavelength sweep for input measured light, the measurement section executes sequential sampling according to the sampling clock from the control section, of a period shifting from the cycle period of the measured light for each wavelength of the wavelength sweep.

Thus, sequential sampling is executed according to the sampling clock of the period shifting from the cycle period of the measured light for each wavelength of the wavelength sweep, whereby when the spectrum of measured light occurring repeatedly is measured, even if a mechanical sweep technique is used, it is made possible to enable the user to observe an instantaneous optical spectrum.

When the optical section executes light dispersion into a spectrum and wavelength sweep for input measured light, the measurement section executes sequential sampling according to the sampling clock whose timing is changed from the control section for each period of the wavelength sweep. Thus, sequential sampling is executed according to the sampling clock whose timing is changed for each period of the wavelength sweep, whereby when the spectrum of measured light occurring repeatedly is measured, even if a mechanical sweep technique is used, it is made possible to enable the user to observe an instantaneous optical spectrum.

In the configuration described above, the sampling head executes sampling according to the sampling clock, and the measurement section executes sequential sampling of output of the sampling head. The sampling head for generating and sampling an electric signal of short duration is installed and an electric signal generated in the optical section is sampled at the sampling head at high time resolution and then A-D conversion of the output is executed and waveform display is produced, whereby wide-band optical spectrum observation is made possible independently of the performance of the A-D converter.

Further, in the configuration described above, three-dimensional waveform display is produced on the waveform display based on the measurement result of the measurement section, whereby when the spectrum of measured light occurring repeatedly is measured, even if a mechanical sweep technique is used, it is made possible to enable the user to observe an instantaneous optical spectrum in a state in which change in the wavelength is also contained.

### BRIEF DESCRIPTION OF THE DRAWINGS

In the accompanying drawings:

FIG. 1 is a functional block diagram to show the configuration of an optical spectrum analyzer of a first embodiment of the invention;

FIGS. 2(a) to (d) are time charts to show the operation state of the optical spectrum analyzer of the first embodiment of the invention;

FIG. 3 is a functional block diagram to show the configuration of an optical spectrum analyzer of a second embodiment of the invention;

FIGS. 4(a) and (b) are schematic representation to schematically show processing of optical pulses in the first and second embodiments of the invention;

FIGS. 5(a) to (d) are time charts to show the operation state of the optical spectrum analyzer of the second embodiment of the invention;

FIG. 6 is a functional block diagram to show the configuration of an optical spectrum analyzer of a third embodiment of the invention;

FIG. 7 is a functional block diagram to show the configuration of an optical spectrum analyzer of a fourth embodiment of the invention;

FIG. 8 is a functional block diagram to show the configuration of an optical spectrum analyzer in a related art;

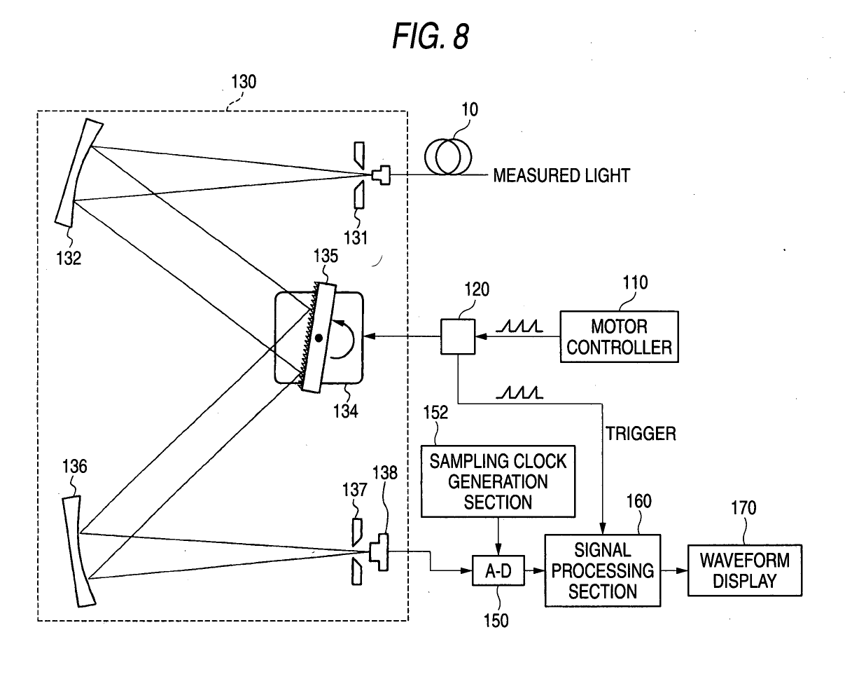

FIGS. 9(a) to (e) are time charts to show the operation state of the optical spectrum analyzer in the related art; and

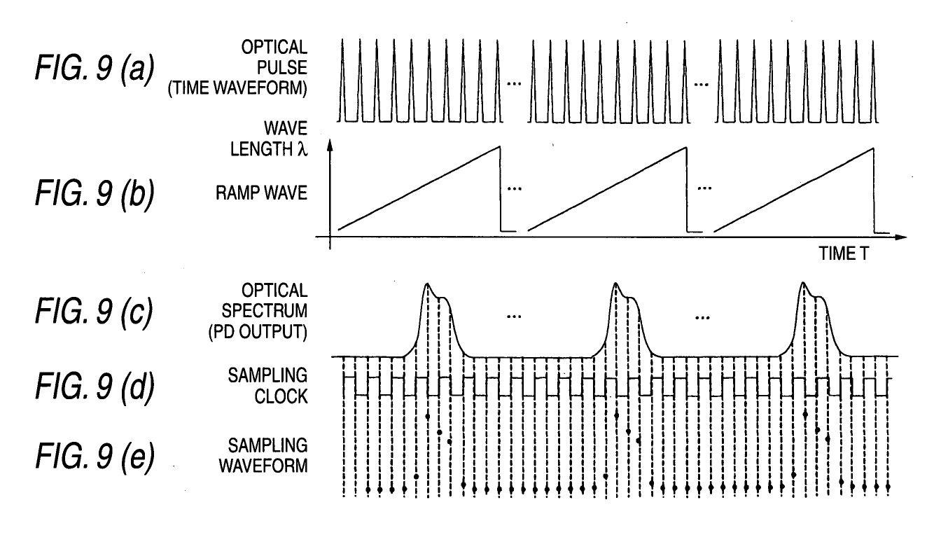

FIGS. 10(a) to (c) are schematic representation to schematically show processing of optical pulses.

### DETAILED DESCRIPTION

The best mode for carrying out the invention (embodiments) will be discussed in detail with reference to the accompanying drawings.

### First Embodiment

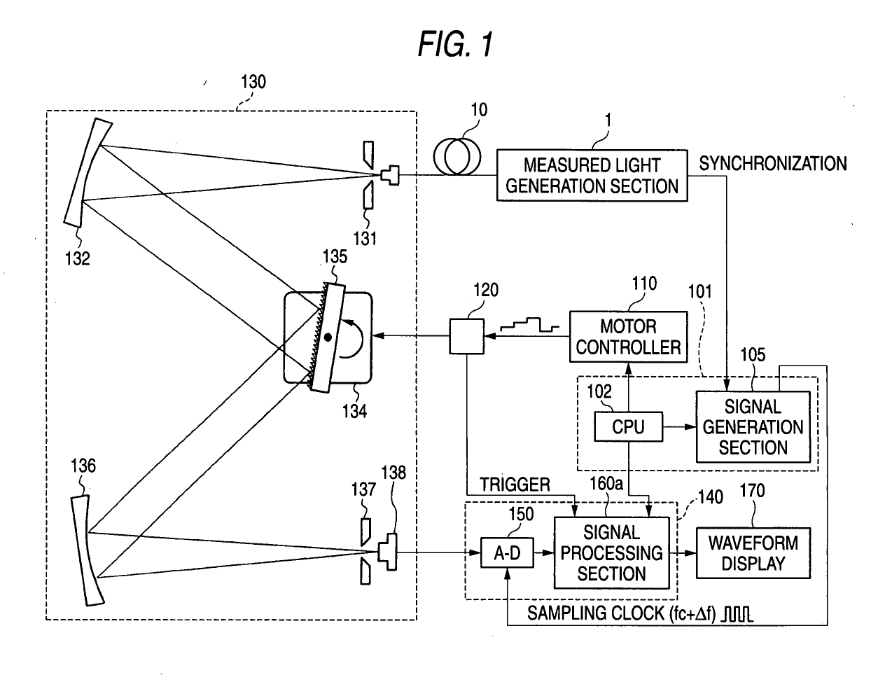

FIG. 1 is a drawing to show the configuration of a measurement system of an optical spectrum analyzer according to a representative Czerny-Turner monochromator system as a first embodiment of the invention.

In FIG. 1, a measured light generation section 1 generates measured light and outputs the measured light to an incidence end of an optical fiber 10.

The optical fiber 10 has the incidence end on which the measured light from the measured light generation section 1 is incident, and transmits the incident measured light. An emission end of the optical fiber 10 on the side of an optical section 130 described later is connected to an incidence slit 131 in the optical section 130 described later.

A control section 101 controls the sections of the optical spectrum analyzer and particularly controls wavelength sweep in the optical section 130 in response to a synchronous signal of the measured light generation section 1 and outputs a sampling clock for sequential sampling of a period shifting from a cycle period of measured light for each wavelength of wavelength sweep to a measurement section 140.

A CPU 102 controls the sections in accordance with a control program in the control section 101 and gives a command to a signal generation section 105, a motor controller 110, and a signal processing section 160a.

The signal generation section 105 receives a command of the CPU 102 in the control section 101 and outputs a sampling clock to an A-D converter 150 in synchronization with a synchronous signal from the measured light generation section 1. The motor controller 110 outputs a ramp wave signal of a predetermined waveform for driving a motor 134 for rotating a diffraction grating 135, and has output connected to a divider 120.

The ramp wave signal of the predetermined waveform supplied from the motor controller 110 is input to the divider 120, which then divides the ramp wave signal for output. The divided output is supplied to the motor 134 and the signal processing section 160a described later.

The optical section 130 executes light dispersion into a spectrum and waveform sweeping for the measured light emitted from the output end of the optical fiber 10, converts the measured light into an electric signal, and outputs the electric signal. It has the incidence slit 131, a concave mirror 132, the motor 134, the diffraction grating 135, a concave mirror 136, an exit slit 137, and a photodetector 138.

The incidence slit 131 is placed in the proximity of the emission end of the optical fiber 10 for limiting a light flux so that the measured light having a predetermined emission angle, of the measured light emitted from the emission end of the optical fiber 10 arrives at the concave mirror 132.

The concave mirror 132 is a kind of collimator means for converting the measured light having a spread angle from the optical fiber 10 incident through the incidence slit 131 into collimated light, and reflects the measured light converted into the collimated light toward the diffraction grating 135. The concave mirror 132 can also be replaced with a collimator lens implemented as a convex lens, etc.

The motor 134 is a rotation drive source to which the ramp wave signal provided by the divider 120 is supplied as a drive signal, and drives the diffraction grating 135 by rotation responsive to the ramp wave signal.

The diffraction grating 135 is an optical element for executing light dispersion of the diffraction angle responsive to the wavelength by reflection interference of a plurality of minute parallel grooves. It receives collimated measured light from the concave mirror 132 and diffracts the dispersed measured light in the direction of the concave mirror 136.

The concave mirror 136 is a kind of light condensing means for condensing dispersed diffraction light which is collimated light for each wavelength from the diffraction grating 135. It condenses the diffraction light toward the photodetector 138. The concave mirror 136 can also be replaced with a condensing lens implemented as a convex lens, etc.

The exit slit 137 is placed in the proximity of the light detection face of the photodetector 138 for limiting a light flux so that the measured light of a predetermined wavelength, of the measured light dispersed through the diffraction grating 135 and condensed on the concave mirror 136 toward the photodetector 138.

The photodetector 138 is a photoelectric conversion element for detecting the measured light of the predetermined wavelength emitted through the exit slit 137 and outputting an electric signal, and has output connected to the A-D converter 150 in the measurement section 140.

The measurement section 140 conducts measurement by sequential sampling of an electric signal from the optical section 130 for each sampling clock, and is made up of the A-D converter 150 for executing A-D conversion based on the sampling clock and the signal processing section 160a for performing signal processing of output of the A-D converter 150.

The A-D converter 150 has input to which the output of the photodetector 138 is connected, executes A-D conversion in response to a sampling clock from the signal generation section 105, outputs a digital signal, and has output connected to the signal processing section 160a. The signal processing section 160a performs signal processing of the digital signal from the A-D converter 150, the sampling result of the measured light of the predetermined wavelength, with the ramp wave signal provided by the divider 120 as a trigger, generates waveform information of the spectrum component of the measured light, and outputs the waveform information to a waveform display 170.

The waveform information output from the signal processing section 160a is input to the waveform display 170 for producing various displays of the waveform information in the forms of graphs and numeric values as a three-dimensional waveform drawing, etc., about the optical spectrum of the measurement result of the measured light on a display screen.

The diffraction grating 135 can be varied at any desired angle by the motor 134 with the parallel axis to the grooves as the center. The motor controller 110 receives a command of the control section 101 and controls the motor 134 to vary the angle of the diffraction grating 135. The diffraction grating 135 diffracts diffraction light of only a specific wavelength component determined by any desired angle from the collimated light in the direction of the concave mirror 136. The concave mirror 136 forms the diffraction light on the exit slit 137. Only the wavelength component within the range of the breadth of the exit slit 137 passes through the exit slit 137.

In FIG. 1, the measured light from the measured light generation section 1 is incident on the optical section 130 from the emission end of the optical fiber 10. At this time, the incidence slit 131 limits a light flux so that the measured light having a predetermined emission angle, of the measured light emitted from the emission end of the optical fiber 10 arrives at the concave mirror 132.

The measured light emitted from the emission end of the optical fiber 10 and arriving at the concave mirror 132 arrives at the diffraction grating 135 as collimated light. At this time, the measured light diffracted through the diffraction grating 135 is dispersed into a spectrum and is in a state in which the diffraction angle changes for each wavelength.

Therefore, the wavelength of the measured light diffracted through the diffraction grating 135 and then condensed on the concave mirror 136 and emitted through the exit slit 137 changes in synchronization with rotation of the diffraction grating 135 and wavelength sweeping is realized.

The measured light emitted through the exit slit 137 is detected at the photodetector 138, which then executes photoelectric conversion of the measured light into an electric signal. The electric signal detected and generated by the photodetector 138 is converted into a digital signal by the A-D converter 150 driven according to a sampling clock from the sampling clock generation section 152.

The signal processing section 160a performs signal processing of the digital signal with a ramp wave signal as a trigger and generates waveform information of the spectrum component of the measured light, and the waveform information is displayed on the waveform display 170. That is, the emission timing through the exit slit 137 changes depending on the wavelength of the light dispersed through the diffraction grating 135 driven by the motor 134 and thus the time response becomes an optical spectrum. Here, the time (light detection timing) can be converted into the wavelength according to the angle of the diffraction grating 135.

Here, since a trigger is required for determining the measurement start point in the signal processing section 160a, a control signal of the motor 134 synchronized with rotation of the diffraction grating 135 is divided by the divider 120 and one is used as a trigger in the signal processing section 160a.

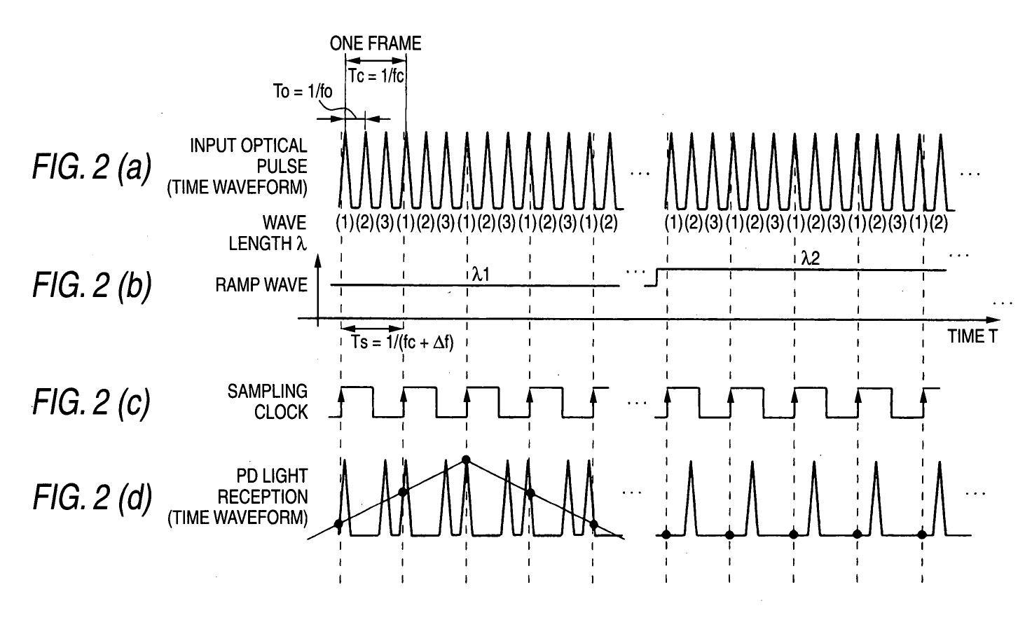

FIG. 2 is a time chart of a signal waveform at the measurement time with the optical spectrum analyzer in the first embodiment shown in FIG. 1. Here, spectrum measurement of measured light wherein wavelength change of pulse in a frame period is repeated every frame period will be discussed as an example.

FIG. 2(a) shows the pulse-like waveform of measured light and FIG. 2(b) shows the waveform of a ramp wave signal from the motor controller 110 for performing wavelength sweep of measured light. FIG. 2(c) shows the waveform of a sampling clock supplied by the signal generation section 105 to the A-D converter 150, and FIG. 2(d) shows the sampling waveform when output of the photodetector 138 is sequentially sampled in the A-D converter 150 in response to the sampling clock.

FIG. 2(a) shows the waveform of input pulses of measured light, wherein the period of one pulse is TO and three different pulses are generated repeatedly in a frame period Tc (frame pulse rate fc)

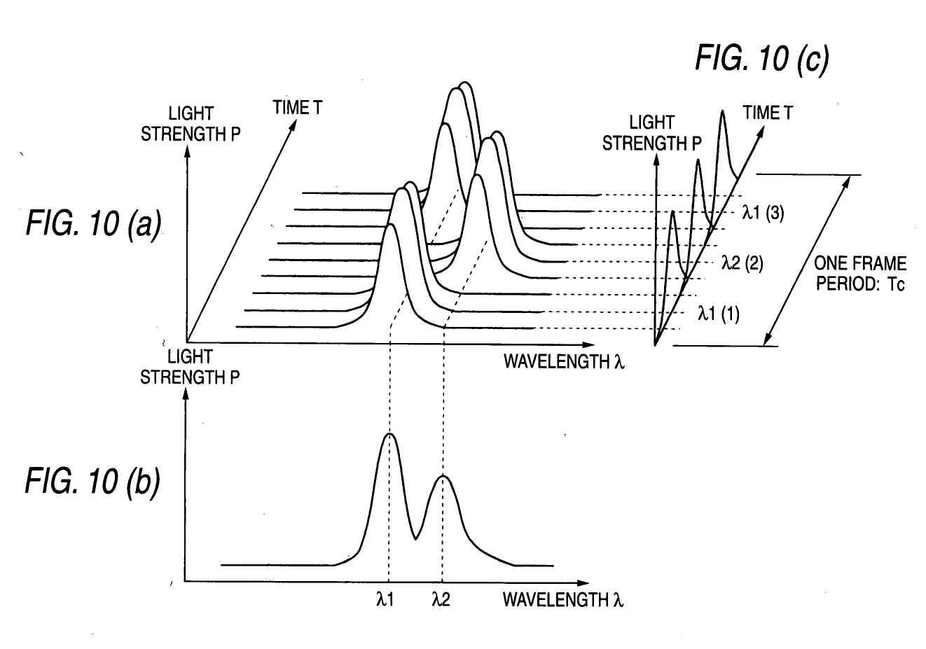

FIG. 10 shows a state of instantaneously switching from wavelength λ1 to wavelength λ2 and again returning to λ1; the phenomenon sequence is assumed to be one frame (period: Tc=1/fc, fc: Frame pulse rate). For simplicity, here, three bits (three pulses) make up one frame; in fact, however, n bits (n: Integer) make up one frame. (1), (2), and (3) in FIG. 10(c) also correspond to (1), (2), and (3) in FIG. 2(a).

First, the control section 101 sets a ramp wave signal corresponding to the wavelength λ1, drives the diffraction grating 135 through the motor 134 from the motor controller 110, and controls the rotation angle of the diffraction grating 135 so as to allow the measured light of the wavelength λ1 to be emitted through the exit slit 137.

Here, to execute sequential sampling of the first (1) pulse (wavelength λ1) in the frame period, more than one sampling is executed across frames with the ramp wave signal (FIG. 2(b)) kept in a given value for λ1. At this time, to execute sequential sampling, more than one sampling is executed (FIG. 2(c)) while a sampling clock is synchronized with the first (1) pulse (FIG. 2(c)→FIG. 2(a) (1)) and the sampling clock period (sampling period) Ts is shifted a little (1/Δf) from the frame period Tc.

In so doing, for the first (1) pulse of the wavelength λ1, the sampling result across the frames is restored in the signal processing section 160a, whereby a similar waveform of the original pulses is obtained (FIG. 2(d)).

The control section 101 controls so as to execute sequential sampling of the second (2) pulse and sequential sampling of the second (3) pulse with the ramp wave signal (FIG. 2(b)) kept in the given value for λ1. In the specific example, since the wavelength of the (2) pulse differs from λ1, the measured light subjected to wavelength sweep cannot be emitted through the exit slit 137 and is not detected at the photodetector 138 and thus, in fact, a similar form of the original pulses is not obtained. Since the wavelength of the (3) pulse is λ1, the measured light is emitted through the exit slit 137 and is detected at the photodetector 138 and a similar form of the original pulses is obtained by sequential sampling in the signal processing section 160a. That is, such sampling is executed in sequence for each of other pulses for each time within one frame period.

Next, the control section 101 sets a ramp wave signal corresponding to the wavelength λ2, drives the diffraction grating 135 through the motor 134 from the motor controller 110, and controls the rotation angle of the diffraction grating 135 so as to allow the measured light of the wavelength λ2 to be emitted through the exit slit 137.

Also here, to execute sequential sampling of each of the first (1) pulse in the frame period, the second (2) pulse in the frame period, and the third (3) pulse in the frame period, more than one sampling is executed across frames with the ramp wave signal (FIG. 2(b)) kept in a given value for λ2. At this stage, since the wavelength of each of the (1) pulse and the (2) pulse differs from λ2, the measured light cannot be emitted through the exit slit 137 and is not detected at the photodetector 138 and thus a similar form of the original pulses is not obtained in the signal processing section 160a. Since the wavelength of the (2) pulse is λ2, the measured light is emitted through the exit slit 137 and is detected at the photodetector 138 and a similar form of the original pulses is obtained by sequential sampling in the signal processing section 160a.

Thus, in the signal processing section 160a, a similar form of the original pulse is obtained in sequence for the pulses different in time and the pulses different in wavelength within the frame period. Thus, as waveform information of the spectrum component of the measurement result of the signal processing section 160a, it is made possible to display the final detection result on the waveform display 170 like a three-dimensional graph having time axis information as in FIG. 10(a) rather than FIG. 10(b) in the related art.

In the specific example given above, sampling period Ts=1/(fc+Δf), but the period may be set to N×Ts (N: Integer). Therefore, the diffraction grating is rotated stepwise slowly in synchronization with the frame period, whereby three-dimensional waveform display is obtained as three-dimensional information of the light strength relative to the wavelength and the time as shown in FIG. 10.

That is, in each wavelength, sequential sampling is executed for each pulse and a similar form of the original pulse is obtained as described above. In this case, to rotate the diffraction grating 135 through the motor 134, the diffraction grating 135 need not be driven at high speed because it may be driven every (a plurality of frame periods required for sequential sampling of one pulse)×(number of pulses within frame period) for sequential sampling, and the time axis information of the detection result is not lost either.

Thus, the sequential sampling method is used, whereby in the signal processing section 160a, instantaneous spectral change in a pulse as shown in FIG. 10(a) rather than simply averaged optical spectrum (FIG. 10(b)) can be captured. This does not depend on the sweep speed and thus can also be sufficiently applied to machine sweep of rotating the diffraction grating 135 with the motor 134 at low sweep speed. It can also be applied to the case where any other sweep means is used.

Although the configuration wherein the measured light generation section 1 outputs a synchronous signal to the signal generation section 105 is shown, a synchronous signal may be output from the signal generation section 105 to the measured light generation section 1. In short, the measured light generation section 1 and the signal generation section 105 may be synchronized with each other.

Measurement of measured light different in wavelength of pulses within a frame is shown by way of example, but the invention is not limited to it; burst or packets maybe used in place of pulses. This means that measurement of measured light different in wavelength of burst or packets within a frame may be executed. In short, limitation to measured light is not made.

Not only in measured light with change in the wavelength of a pulse or a pulse string, but also in repetition of a pulse having a given wavelength, minute wavelength fluctuation of a pulse or a pulse string and change in a light strength distribution can be observed.

The example wherein the sampling clock is synchronized every frame period is used, in which case the pulse time and wavelength change within a frame can be captured. If the sampling clock is not synchronized with the frame period, although each pulse in the frame cannot be observed, statistical data of the pulses can be obtained and thus the mode is effective for waveform evaluation.

### Second Embodiment

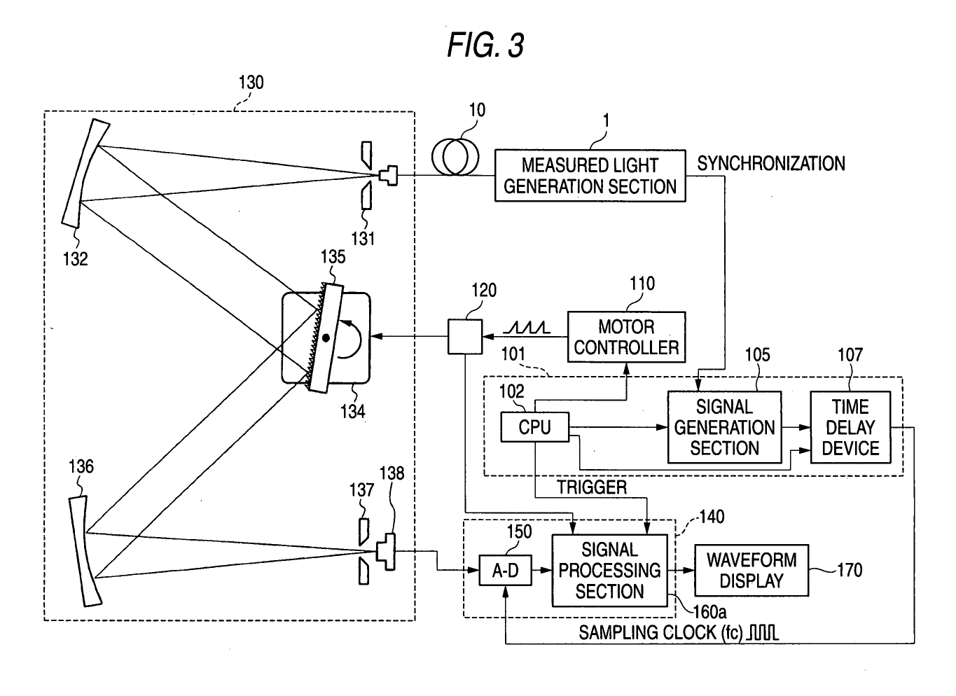

FIG. 3 is a block diagram to show the configuration of a measurement system of an optical spectrum analyzer according to a representative Czerny-Turner monochromator system as a second embodiment of the invention.

Components identical with those in FIG. 1 are denoted by the same reference numerals in FIG. 3 and will not be discussed again. The second embodiment in FIG. 3 differs from the first embodiment in FIG. 1 in that it has a time delay device 107 to which a control signal from a control section 101 and a sampling clock from a signal generation section 105 are input, the time delay device 107 for supplying output to an A-D converter 150.

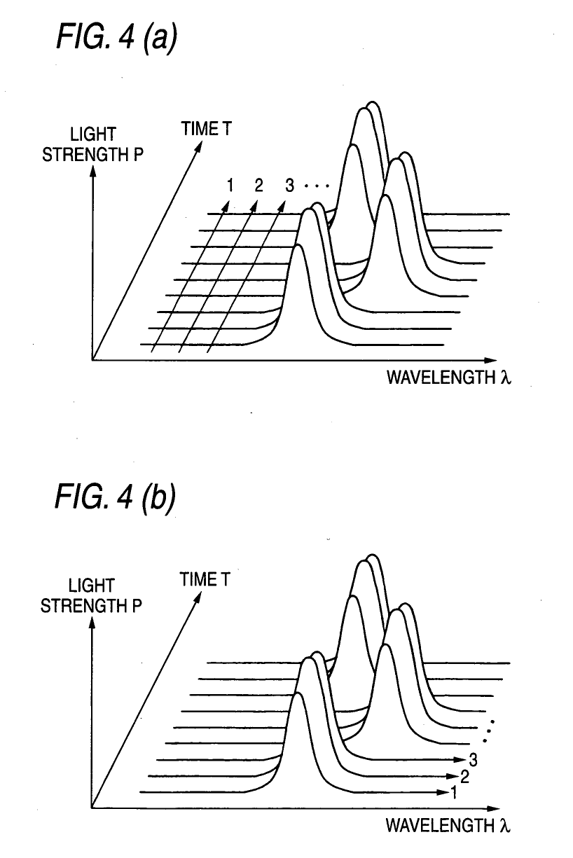

In the first embodiment described above, a different wavelength is swept gradually in such a repetitive manner that a plurality of pulses are sequentially sampled within the same wavelength and then the wavelength is switched to a different wavelength and sequential sampling is executed in the wavelength. This is represented as an image as in 1, 2, 3, . . . in FIG. 4(a).

In the second embodiment, unlike the first embodiment, while wavelength sweep is executed about the same point of pulse, the point is shifted gradually as shown in 1, 2, 3, . . . in FIG. 4(b).

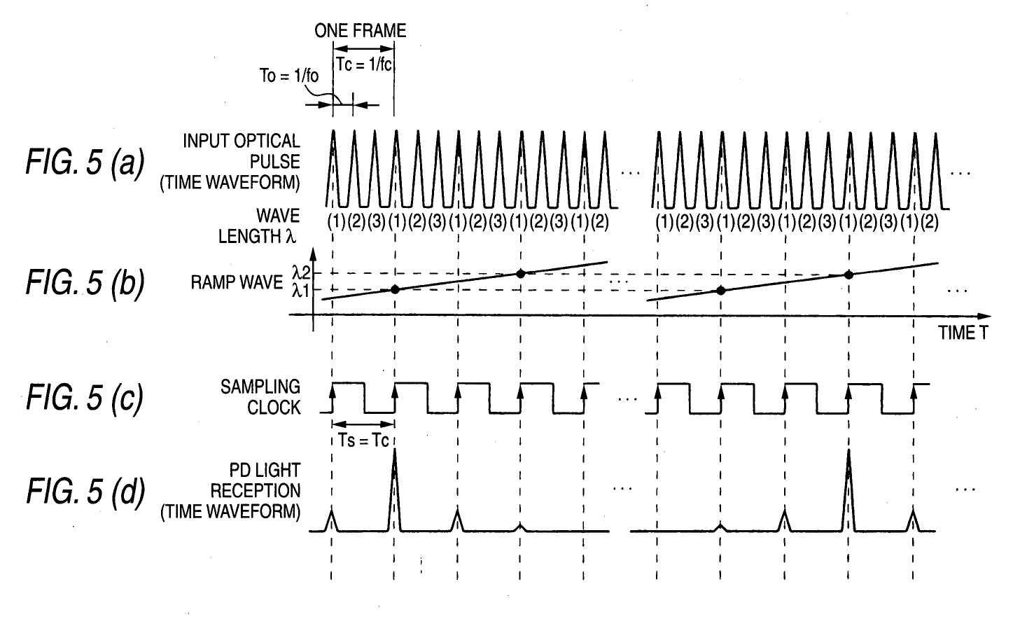

FIG. 5 is a time chart at the operation time of the second embodiment. In the optical spectrum analyzer of the configuration shown in FIG. 3, measured light and a sampling clock need to be synchronized with each other as in the configuration in FIG. 1; in the second embodiment, however, the sampling clock frequency is fc rather than fc+Δf.

Accordingly, from the viewpoint of pulses, wave sweep is always executed at the same timing of pulse, as shown in FIG. 5. Therefore, to see change in an optical spectrum based on the time in the pulse or see the optical spectrum of another pulse, the time delay device 107 becomes necessary for shifting the timing. It is necessary to send a control signal from the control section 101 to the time delay device 107 in agreement with the wavelength sweep period for shifting the timing. Therefore, upon reception of a signal from a motor controller for controlling wavelength sweep, the control section 101 sends a control signal to the time delay device 107 for gradually shifting the timing to another pulse, as shown in FIG. 3.

FIGS. 5(a) to (d) shows the state in which wavelength sweep is executed just at the peaks of pulses (1) and (2). The sampling timing is shifted little by little by the time delay device 107, whereby three-dimensional waveform display as three-dimensional information of the light strength relative to the wavelength and the time can be produced as a measurement section 140 performs signal processing as with the first embodiment.

Since sequential sampling is also used in the second embodiment, a diffraction grating 135 is slowly rotated, whereby in a signal processing section 160a, instantaneous spectral change in a pulse as shown in FIG. 10(a) rather than simply averaged optical spectrum (FIG. 10(b)) can be captured. This does not depend on the sweep speed and thus can also be sufficiently applied to machine sweep of rotating the diffraction grating 135 with a motor 134 at low sweep speed. It can also be applied to the case where any other sweep means is used.

### Third Embodiment

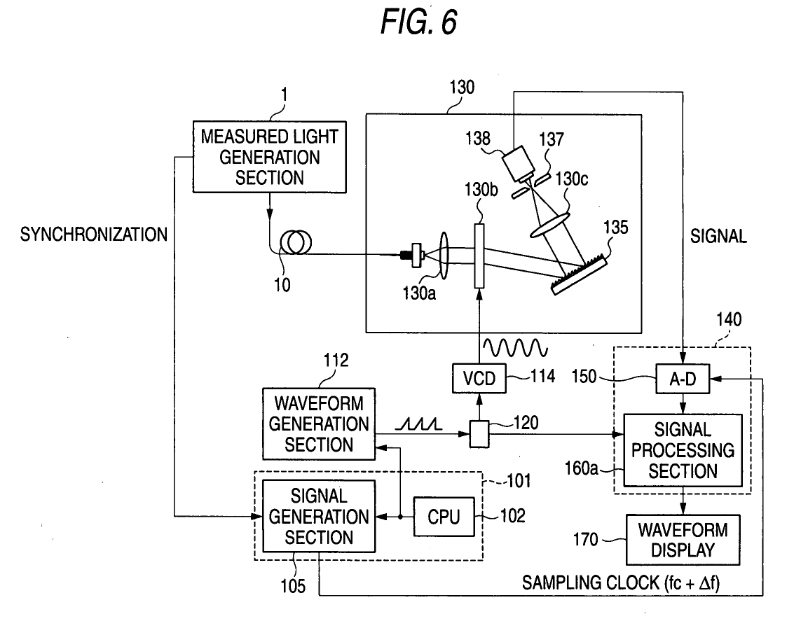

FIG. 6 is a block diagram to show the configuration of an optical spectrum analyzer with a sequential sampling method applied to an optical system using an acousto-optic deflector (AOD) in place of a diffraction grating rotated by a motor as means for executing wavelength sweep as a third embodiment of the invention.

An optical section 130 will be discussed centering on the differences from the first and second embodiments described above.

In the third embodiment, an optical section 130 uses an acousto-optic deflector (AOD) 130b through which the propagation angle of diffraction light changes by an electric signal as an example of deflection section in place of the diffraction grating 135 of the motor 134.

A voltage-controlled oscillator (VOC) 114 for receiving a ramp wave signal, generating a radio frequency (RF) signal of the frequency responsive to the ramp wave signal, and supplying the RF signal to the AOD 103b is provided for deflecting the propagation angle of the diffraction light of the AOD 103b.

Although the motor controller generates a ramp wave signal in the first embodiment, etc., a waveform generation section 112 generates a ramp wave signal under the control of a control section 101 as an equivalent function.

In the optical section 130 shown in FIG. 6, a collimator lens 130a is used in place of the concave mirror 132 and a condensing lens 130c is used in place of the concave mirror 136 because of the relation of placement, but they serve optical functions equivalent to those of the concave mirrors in the first and second embodiments.

Measured light is output to space through an optical fiber 10 and is converted into collimated light through the collimator lens 130a. When the collimated light of the measured light is made incident on the AOD 130b, the propagation angle of the diffraction light changes according to the RF frequency of VCO output from the VCO 114 for generating the frequency responsive to the voltage of the ramp wave signal.

Therefore, as the ramp wave signal is input to the VCO 114, the wavelength emitted through an exit slit 137 is swept with a diffraction grating fixed mechanically.

Thus, although the internal configuration of the optical section 130 differs, the manner in which some control signal is input for executing wavelength sweep and photodetector output is sampled is the same as that in the first and second embodiments, so that the sequential sampling method can also be applied to the wave sweep method using the AOD 130b.

That is, the sequential sampling method shown in the time chart of FIG. 2 in the first embodiment and the sequential sampling method shown in the time chart of FIG. 5 in the second embodiment can be applied intact by supplying a ramp wave signal to the VCO 114.

Since sequential sampling is also used in the third embodiment, the AOD 130b is slowly driven, whereby three-dimensional information of the light strength relative to the wavelength and the time as shown in FIG. 10(a) can be produced.

That is, the sequential sampling method is used, whereby as the waveform information of the spectrum component of the processing result of a signal processing section 160a, it is made possible to display the final detection result on a waveform display 170 like a three-dimensional graph having time axis information as in FIG. 10(a) rather than simply averaged optical spectrum as in FIG. 10(b) in the related art.

Since the sequential sampling method described above does not depend on the sweep speed, the components need not be driven at high speed and the sequential sampling method can be sufficiently applied. It can also be applied to the case where any other sweep means is used.

In the third embodiment, any of various beam deflection elements of a galvano scanner, a polygon mirror, an MEMS (Micro Electro Mechanical Systems) mirror, etc., may be adopted in place of the AOD 130b as the deflection section for executing wavelength sweep.

In the monochromator, a representative Czerny-Turner optical system is shown in FIG. 1, but any of various optical placements of Ebert type, Littrow type, Monk-Gillieson type, etc., may be used. In this case, the method shown in the time chart of FIG. 2 in the first embodiment and the method shown in the time chart of FIG. 5 in the second embodiment can also be applied.

### Fourth Embodiment

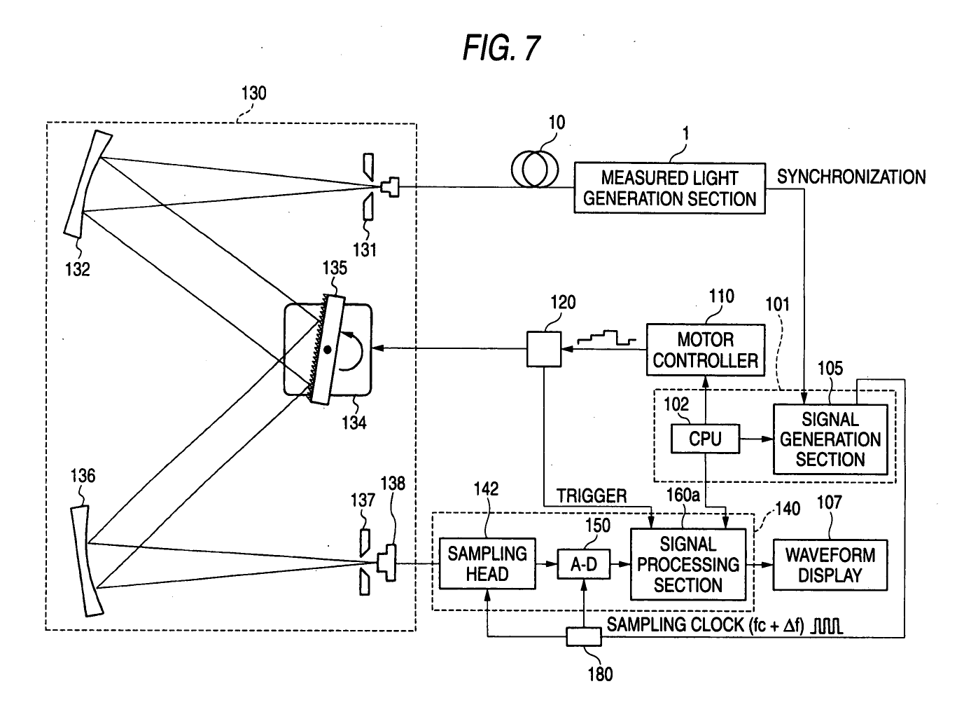

FIG. 7 is a block diagram to show the configuration of an optical spectrum analyzer of a sequential sampling method using a sampling head for more speeding up (higher time resolution) as a fourth embodiment of the invention.

The fourth embodiment will be discussed centering on the differences from the first and second embodiments described above. In an optical spectrum analyzer of the fourth embodiment, a sequential sampling measurement system wherein a sampling head 142 is placed at the stage preceding an A-D converter 150 is applied.

Generally, a photodetector 138 has a wider frequency band than the A-D converter 150. Therefore, the response speed of the whole of the optical spectrum analyzer is determined depending on the A-D converter.

Then, the sampling head 142 for generating and sampling an electric signal of short duration as used with a sampling oscilloscope, etc., is placed between output of the photodetector 138 and input of the A-D converter 150 and samples the output of the photodetector 138 at high time resolution, the A-D converter 150 executes A-D conversion of the output, and waveform display is produced. According to the configuration, optical spectrum observation with a band of 100 GHz or more is made possible and even observation of a 1-bit instantaneous optical spectrum of a high-speed communication optical signal is made possible.

For wavelength sweep in an optical section 130, the method shown in the time chart of FIG. 2 in the first embodiment and the method shown in the time chart of FIG. 5 in the second embodiment can be applied intact. Although not shown, the AOD 130b of the third embodiment can also be applied to wavelength sweep.

Since sequential sampling is also used in the fourth embodiment, three-dimensional information of the light strength relative to the wavelength and the time as shown in FIG. 10(a) can be produced. That is, the sequential sampling method is used, whereby as the waveform information of the spectrum component of the processing result of a signal processing section 160a, it is made possible to display the final detection result on a waveform display 170 like a three-dimensional graph having time axis information as in FIG. 10(a) rather than simply averaged optical spectrum as in FIG. 10(b) in the related art. Since the sequential sampling method described above does not depend on the sweep speed, the components need not be driven at high speed and the sequential sampling method can be sufficiently applied. It can also be applied to the case where any other sweep means is used. The sampling head 142 is placed at the stage preceding the A-D converter 150, whereby it is also made possible to handle a high-speed communication optical signal exceeding the response speed of the A-D converter 150.

What is claimed is:

1. An optical spectrum analyzer comprising:
an optical section for executing light dispersion into a spectrum and wavelength sweep for input measured light, converting the measured light into an electric signal, and outputting the electric signal;
a control section for controlling the wavelength sweep of said optical section and outputting a sampling clock of a period shifting from a cycle period of the measured light for each wavelength of the wavelength sweep; and
a measurement section for executing sequential sampling of the electric signal from said optical section for each sampling clock.

2. An optical spectrum analyzer comprising:
an optical section for executing light dispersion into a spectrum and wavelength sweep for input measured light, converting the measured light into an electric signal, and outputting the electric signal;
a measurement section for processing the electric signal from said optical section for each sampling clock; and
a control section for controlling the wavelength sweep of said optical section and changing the timing of sampling of said measurement section for each period of the wavelength sweep.

3. The optical spectrum analyzer as claimed in claim 1 wherein said measurement section has:
a sampling head to which the electric signal from said optical section is input, the sampling head for sampling according to the sampling clock; and
an A-D converter to which output of the sampling head is input, the A-D converter for converting analog data into digital data according to the sampling clock.

4. The optical spectrum analyzer as claimed in claim 2 wherein said measurement section has:
a sampling head to which the electric signal from said optical section is input, the sampling head for sampling according to the sampling clock; and
an A-D converter to which output of the sampling head is input, the A-D converter for converting analog data into digital data according to the sampling clock.

5. The optical spectrum analyzer as claimed in claim 1 further comprising:
a waveform display for producing three-dimensional waveform display based on the measurement result of said measurement section.

6. The optical spectrum analyzer as claimed in claim 2 further comprising:
a waveform display for producing three-dimensional waveform display based on the measurement result of said measurement section.

7. The optical spectrum analyzer as claimed in claim 1 wherein said optical section has:
a diffraction grating for executing light dispersion of the measured light into a spectrum; and
a motor for rotating the diffraction grating according to a command of said control section.

8. The optical spectrum analyzer as claimed in claim 2 wherein said optical section has:
a diffraction grating for executing light dispersion of the measured light into a spectrum; and
a motor for rotating the diffraction grating according to a command of said control section.

9. The optical spectrum analyzer as claimed in claim 1 wherein said optical section has:
a deflection section to which the measured light is input, the deflection section for deflecting the measured light according to a command of said control section; and
a diffraction grating on which diffraction light provided by the deflection section is made incident, the diffraction grating for executing light dispersion into a spectrum.

10. The optical spectrum analyzer as claimed in claim 2 wherein said optical section has:
a deflection section to which the measured light is input, the deflection section for deflecting the measured light according to a command of said control section; and
a diffraction grating on which diffraction light provided by the deflection section is made incident, the diffraction grating for executing light dispersion into a spectrum.

11. The optical spectrum analyzer as claimed in claim 1 wherein the measured light is synchronized with the sampling clock.

12. The optical spectrum analyzer as claimed in claim 2 wherein the measured light is synchronized with the sampling clock.

13. The optical spectrum analyzer as claimed in claim 1 wherein the measured light is repeated every frame period with the sampling clock and frame period synchronized with each other.

14. The optical spectrum analyzer as claimed in claim 2 wherein the measured light is repeated every frame period with the sampling clock and frame period synchronized with each other.
